(19) United States
(12) Patent Application Publication
(10) Pub. No.: US 2024/0100460 A1
(43) Pub. Date: Mar. 28, 2024

(54) Filter Element With Gasket Surrounding Filter Head

(71) Applicant: Herding GmbH Filtertechnik, Amberg (DE)

(72) Inventors: Walter Herding, Hahnbach (DE); Urs Herding, Amberg (DE); Egid Koller, Theuern (DE); Alexander Stauber, Amberg (DE)

(73) Assignee: Herding GmbH Filtertechnik, Amberg (DE)

(21) Appl. No.: 17/769,066

(22) PCT Filed: Oct. 13, 2020
(86) PCT No.: PCT/EP2020/078762

§ 371 Date: May 26, 2022

(30) Foreign Application Priority Data
Oct. 15, 2019 (DE) 10 2019 127 739.6

(51) Int. Cl. B01D 46/24; B01D 46/52

(52) U.S. Cl. CPC B01D 46/2403; B01D 46/522; B01D 2201/34; B01D 2239/1208

(57) ABSTRACT

A filter element including a throughflow-porous filter body extending between a head end and a longitudinally opposite foot end, wherein a head structure is formed at the head end of the filter element, the head structure having at least one seal configured to seal the filter element with respect to a filter element holder, wherein the head structure has a sidewall extending basically in the longitudinal direction and the seal is formed on the basically longitudinally extending sidewall of the head structure of the filter element.

The invention relates to a filter element, a filter element holder for a filter element, a filter device, and a method of manufacturing a filter element.

Such filter elements are used in industry in factories and plants in a wide variety of industrial branches, for example in the automotive industry, the chemical industry, the food industry or in the production of building materials.

Filter elements being porous to permit flow therethrough and having inherent stability, i.e. throughflow-porous, inherently stable filter elements of the type according to the invention may have a filter body made of sintered-together polyethylene particles or, for use at higher temperatures, of a more temperature-resistant plastic, such as polyphenylene sulfide.

The filter elements have a filter body on which a filter head is formed. The filter head is used to secure the filter element in a filter device. The filter head must ensure both sealing and retention in the filter device. For this reason, in known filter elements, the filter head is manufactured as a separate component and connected to the filter body, for example by molding the filter head to the filter body. In addition, the filter head is further reinforced by metal inserts. Because of the resulting complex construction of the filter head, the manufacturing process for the known filter elements so far has been difficult to automate.

### SUMMARY

It is therefore an object of the present invention to provide a filter element that is easier to manufacture, in particular in a manufacturing process permitting easier automation.

A filter element according to the invention comprises a throughflow-porous filter body extending between a head end and a longitudinally opposite foot end. At the head end of the filter body, there is formed a head structure cooperating with a filter element holder of a filter device, the head structure having at least one seal adapted to seal the filter element with respect to a filter element holder. The head structure has a sidewall extending basically in the longitudinal direction, and the seal is formed on said basically longitudinally extending sidewall of the head structure of the filter element.

Furthermore, the present invention relates to a filter element holder for receiving a filter element according to the invention, comprising a support plate having at least one filter element receptacle into which the filter element according to the invention can be inserted such that the filter element is seated with its head structure in the filter element receptacle.

Another aspect of the present invention relates to a combination of the filter element according to the invention and the filter element holder according to the invention. In this regard, the filter element is insertable into the filter element holder such that, in the inserted state, the filter element separates a raw fluid space from a clean fluid space of a filter device. The sidewall of the head structure comprises a seal cooperating with the filter element receptacle to seal the filter element with respect to the filter element holder, in particular in cooperation with a sealing element extending transversely to the longitudinal direction.

The invention relates furthermore to a filter device comprising a raw fluid space, a clean fluid space and the combination of filter element and filter element holder according to the invention. The filter element is inserted into a filter element receptacle formed in the filter element holder, such that the filter element in the inserted state separates the raw fluid space from the clean fluid space.

An additional aspect of the invention relates to a method of manufacturing a filter element according to the invention. The method comprises manufacturing a throughflow-porous and inherently stable filter body and forming a head structure on the filter body, wherein the head structure is provided with at least one seal configured to cooperate with a filter element holder of a filter device in order to seal a clean fluid space from a raw fluid space of the filter device. In particular, the seal is formed on a longitudinally extending sidewall of the head structure. The manufacture of the filter element can be automated.

The filter element according to the invention is easier to manufacture than known filter elements. In particular, fully automated manufacture of the filter element is feasible because the head structure does not require any special reinforcements. In particular, the head structure can be made of the same material as the filter body, if desired even in the same manufacturing process.

The filter element is intended in particular to be mounted on a filter element holder of a filter device. The filter element holder, together with the filter element installed therein, separates a clean fluid side from a raw fluid side of the filter device. In the installed state, the filter element is secured to and supported by the filter element holder. The arrangement of the seal on a longitudinally extending sidewall of the head structure according to the invention permits a configuration in which the seal, in the installed state, leads only to the formation of a sufficiently fluid-tight seal in cooperation with a counter-sealing structure on the filter element holder. However, it is no longer necessary that the interaction of seal and counter-sealing structure also provide for retention or attachment of the filter element to the filter element holder, or substantially support such retention or attachment. Rather, the filter element according to the invention may be constructed such that the function of securely fastening and supporting the filter element in the filter element holder is provided by other parts or structures on the head structure than the seal. This design allows the head structure to be made entirely of only one material, in particular a plastic material. In particular, the head structure can now be made of the same plastic material as the filter body. It is no longer necessary to provide additional reinforcing elements or stiffening structures in the head structure, because the functions of providing sealing and holding/fastening the filter element in the filter element holder are performed by various parts of the head structure

For example, the filter element including the head structure can be manufactured entirely in the same sintering process in which the filter body is manufactured. It is only necessary to ensure that the sidewall of the head structure extending in the longitudinal direction is formed during the sintering process and that this sidewall is provided with the seal. This can be done during sintering of the filter body (for example, by appropriately structuring a region of the sidewall that is to form a sealing abutment surface), or it can be done subsequently to sintering (e.g. by providing a separate sealing element cooperating with the sidewall).

The filter element is inherently stable, i.e. the filter body itself already has sufficient rigidity to allow the filter element to be erected. Thus, in principle, no further supporting structures are required to set up the filter element in a filter device. The filter body of the filter element is throughflow-porous and allows (possibly with the aid of an additional surface coating) the filtering of a raw fluid which carries foreign substances and/or foreign particles with it when passing through the filter element. The foreign substances remain on the throughflow-porous filter body on the raw fluid side. A cleaning-off device can be used to remove the foreign substances from the filter body. For example, a cleaning-off device operating according to the compressed-air pulse principle can be provided for this purpose, which applies compressed-air pulses to the filter element, in particular according to the counterflow principle in the opposite direction to the flow direction of the clean fluid flowing off from the filter element on its clean fluid side.

The head end of the filter element is to be referred to in particular as that end of the filter element which, when the filter element is installed in a filter device, lies close to the filter element holder. The head structure enables, on the one hand, secure fastening of the filter element in the filter element holder and, on the other hand, also a good sealing effect between the clean fluid side and the raw fluid side of the filter device in the installed state of the filter element.

A surface/wall that extends in the longitudinal direction of the filter element extends parallel to the direction in which the filter element is inserted into or removed from the filter element holder. The expression “the surface/wall extends substantially in the longitudinal direction” is intended to express that the surface/wall need not be exactly parallel to the longitudinal direction, but may also extend at an acute angle inclined to the longitudinal direction, for example at an angle of up to 15 degrees to the longitudinal direction. For example, the longitudinal direction may be the axis of a truncated pyramid or truncated cone, with the lateral surface formed on the head structure lying on the lateral surface of this truncated pyramid or truncated cone.

When the filter element is inserted into the filter element holder, the seal can indeed come into a certain frictional and/or positive engagement with the counter-sealing structure of the filter element holder, so that sufficient sealing tightness is provided against the passage of the raw fluid to the clean fluid side or vice versa. This means that a certain preload is transmitted via the seal in order to produce a tight fit between the seal on the head structure of the filter element and the counter-sealing structure on the filter element holder cooperating therewith. In contrast, no forces—at least no significant forces—need to be transmitted to hold, secure and/or support the filter element in the filter element holder, in particular to secure the filter element against longitudinal displacement, by the cooperation of seal and counter-sealing structure. In particular, the seal and counter-sealing structure should even be relieved of the transmission of such forces. To secure the filter element against displacement in the longitudinal direction, there may be provided other regions of the head structure or the head structure may have other retaining arrangements.

In the simplest case, the seal provided on the head structure may have the configuration of an abutment surface formed on an outer surface of the sidewall which, when installed, comes into sealing abutment with a corresponding mating abutment surface of the filter element holder. To achieve a better sealing effect, the abutment surface and mating abutment surface may have a more complex structure or geometry, for example in the manner of a labyrinth seal. However, it is convenient to form a seal between the sidewall of the head structure of the filter element and the mating sealing surface cooperating therewith on the filter element holder, which may have a sealing element arranged between these elements, for example a sealing ring or a sealing compound. The sealing effect can be improved by a special geometry of the sidewall and/or counter-sealing structure, for example such that a certain preload is exerted on the sealing element in the installed state.

The seal can be formed on the sidewall of the head structure such that it extends around a clean fluid outlet opening formed in the head structure in at least partially circumferentially surrounding manner, in particular in completely circumferentially surrounding manner. In particular, the seal may annularly surround the clean fluid outlet opening. As already pointed out, the seal takes up no or only slight holding forces when the filter element is installed and therefore need not be of particularly solid or stable design.

In particular, the seal can have a sealing element extending transversely to the longitudinal direction in order to seal the filter element with respect to the filter element holder. Such a sealing element is particularly effective for separating a raw fluid space in which the raw fluid is located from a clean fluid space in which the clean fluid is located.

A recess for receiving the sealing element can be formed in the sidewall, for example a recess formed as a groove. In particular, the recess can extend basically orthogonally to the longitudinal direction, for example in such a way that the groove formed in the sidewall surrounds the clean fluid outlet opening in ring-like manner. Such a recess can ensure secure positioning of the sealing element on the sidewall, even when a preload is applied to the sealing element during installation of the filter element in the filter element holder.

For example, the filter element may have a sealing element extending transversely to the longitudinal direction, which cooperates with the sidewall, in particular with the recess, to seal the filter element with respect to the filter element holder. The sealing element may be made of a material with elastomeric properties commonly used for seals, for example synthetic rubber (ethylene-propylene-diene rubber EPDM, fluorine rubber FKM/FPM, acrylonitrile-butadiene rubber NBR), thermoplastic polyurethane, polytetrafluoroethylene, polyacetal, silicone. The sealing element can be, for example, an O-ring, delta ring, X-ring, or T-ring, relative to a cross-section of the sealing element. However, the sealing element may also comprise a fiber seal or a foamed-on seal. It is also conceivable that the sealing element has a varying cross-section in the circumferential direction around the head structure. For example, in areas of the head structure where particularly large thermal expansion of the filter element at operating temperature is to be expected, the sealing element can have a larger cross-section than in other areas. In this way, in areas where greater thermal expansion of the filter element is expected, more elastic mass of the sealing element is available to take up this thermal expansion.

Although in principle a single sealing element is sufficient, at least when the sealing element completely surrounds the clean fluid outlet opening, in certain embodiments the sidewall may even have multiple recesses so that multiple sealing elements can be attached to the head structure. This can increase the sealing tightness between the filter element and the filter element receptacle. It is also possible to arrange a plurality of sealing elements, each of which does not completely surround the clean fluid outlet opening, offset from one another in the direction of the circumference of the clean fluid outlet opening.

The clean fluid outlet opening may be formed in an end wall arranged at the head end of the filter body. To prevent flow losses of the clean fluid flowing away from the filter element, the clean fluid outlet opening may occupy a major part of the end wall, in particular 80 percent or more. It may also be sufficient for the clean fluid outlet opening to occupy only a portion of the end wall, for example about 70 to 80 percent of the end wall.

The filter element may have a pocket-shaped configuration with at least three sidewalls, in particular at least four sidewalls, and at least one foot end wall connecting the sidewalls to each other at a foot end opposite the head end. The pocket-shaped configuration may have an angular or rounded cross-section. In particular, the pocket-shaped configuration may also have an oval or round cross-section, such that the filter element assumes a more tubular shape as in a filter cartridge. At the head end of the filter element, the clean fluid outlet opening is formed in a head end wall. The sidewalls extend substantially parallel to an insertion direction in which the filter element moves when inserted into the filter element holder. Normally, the direction of flow of the clean fluid flowing away from the filter element is parallel to the insertion direction until it reaches the clean fluid outlet opening. The end walls extend basically transversely to the longitudinal direction, in particular orthogonally to the longitudinal direction, and also transversely to the direction of flow of the clean fluid flowing away from the filter element. In particular, the at least one foot end wall forms a foot or base of the filter pocket.

When the filter element has four sidewalls, the filter element may have the shape of a narrow and wide box, with two wide sidewalls and two narrow sidewalls connecting the two wide sidewalls. The narrow sidewalls may extend orthogonally to the wide sidewalls. The wide sidewalls extend in the longitudinal and width directions of the filter element. The narrow sidewalls extend in the longitudinal and depth directions of the filter element.

In embodiments in which a sealing element cooperating with the abutment surface of the head structure is provided, the sealing element may have a larger cross-section in the region of the narrow sidewalls than in the region of the wide sidewalls. This thickening of the sealing element in the region of the narrow sidewalls can accommodate increased thermal expansion of the filter element at higher temperatures, for example at 50° C. or more. In the region of the thickening, the sealing element provides more elastic mass that can be compressed as the filter element expands to obtain length compensation. Since the thermal expansion of the filter element occurs primarily in the direction of the wide sidewalls, it is sufficient to design the sealing element with a larger cross-section in the region of the narrow sidewalls.

A region of the sidewalls can form the filter body. Optionally, the foot end wall can also form part of the filter body. The foot end wall may also provide a stiffening and/or mounting guide for the filter element.

A clean fluid space can be formed between the sidewalls, in which a clean fluid flows outwardly that is formed from a raw fluid after passage thereof through the sidewalls. The sidewalls with the foot end wall thus form a filter pocket or bag. The sidewalls basically extend in a longitudinal direction, i.e., parallel to the longitudinal direction. Alternatively, the sidewalls may extend at an acute angle to the longitudinal direction, in particular at an angle of less than or equal to 15° and in particular diverging from the foot end to the head end, with the end wall formed at the head end having a larger area than the foot end wall.

The clean fluid exits the filter element through the clean fluid outlet opening. Through the clean fluid outlet opening, the compressed-air pulse generated by the cleaning-off device can also be introduced into the filter element against the flow of the clean fluid, in particular toward the sidewalls and/or end walls forming the filter surface of the filter element.

At least one of the two wide sidewalls may have a zig-zag-like or corrugated configuration, with peaks and valleys having a course extending generally in the longitudinal direction of the filter element. Peaks and valleys generally extend from the head end of the filter element to the foot end of the filter element.

The peaks and valleys in the head structure may flatten toward the clean fluid outlet opening, such that the clean fluid outlet has a substantially rectangular cross-section for clean fluid flow. In this regard, the cross-section for the clean fluid flow may be largest at the outlet opening (i.e. the clean fluid outlet) where the cross-section is nearly rectangular.

The head structure may be formed to fix and hold the filter element to the filter element holder. Thus, an additional retaining structure of the filter element is not cogently necessary.

For forming a retaining structure, the head structure may form at least one outwardly projecting protrusion configured to cooperate with a complementary or mating retaining structure formed on the filter element holder to secure the filter element against displacement in the longitudinal direction, in particular against displacement in the insertion direction. The directional indication “outwardly” in this regard relates to the longitudinal direction, in particular orthogonal to the longitudinal direction, i.e. in width direction and/or in depth direction. In the installed state, the protrusion thus takes up forces for retaining or fixing the filter element in the filter element holder, in particular against displacement in the longitudinal direction.

The head structure can project outwardly beyond at least one of the sidewalls (wide sidewalls and/or narrow sidewalls) at least in a portion thereof, so that the head structure itself forms a protrusion which forms an end face directed toward the foot end of the filter element and which cooperates with a mating end face formed on the filter element holder to secure the filter element against displacement in the longitudinal direction, in particular against displacement in the insertion direction.

The filter element may be adapted to be suspended in the filter element holder of a filter device by engagement of the end face directed towards the foot end of the filter element with the mating end face of the filter element holder.

A cavity formed in the head structure, which connects the clean fluid outlet opening and the cavity or clean fluid space between the sidewalls of the filter element, may be divided by at least one partition wall extending basically in the longitudinal direction. This increases the stability of the head structure and thus ensures high durability.

The partition wall can connect two opposite wide sidewalls. The clean fluid space between the sidewalls may have a cross-section that increases from the first end wall at the foot end to the second end wall at the head end.

The clean fluid space and the cavity or cavities of the head structure may form an outlet funnel for the clean fluid, the funnel cross-section (funnel opening) of which increases with increasing distance from the foot end of the filter element.

The filter element may have an integral design, in particular the head structure may be formed integrally with the filter body. This permits the filter element to be manufactured in a fully automated manner, thus allowing the production of large quantities. Integral means that the filter element (including filter body, head structure and foot structure) is manufactured as one single piece. For example, the filter element including filter body and head structure may be sintered or otherwise formed in a single piece. This method of manufacture is simpler than that used hitherto, in which a number of components, each sintered or molded separately, had to be joined together, or the head structure had to be injection-molded or glued to the filter body in a separate step, and metal reinforcing parts had to be attached in addition. In contrast, there are no intermediate or preliminary components for the filter element according to the invention that then have to be joined together. In addition, mechanical post-processing steps are largely unnecessary.

For example, the filter body may be manufactured as a sintered structure from a sintered particulate material and the head structure may be integrally sintered together with the filter body. The filter body and the head structure may be constructed of plastic particles sintered together, particularly polyethylene particles sintered together or polyphenylene sulfide particles sintered together.

The filter body and head structure may be manufactured by infrared sintering. The thermal energy required for infrared sintering may be provided by gas or by electricity. Infrared sintering, especially when heat energy is provided by means of electricity, makes it possible in particular to carry out sintering in different areas of the filter element with different temperatures or amounts of energy. This makes it possible to achieve specifically desired mechanical properties in certain areas, for example in terms of porosity and mechanical strength. This permits the generation of different properties for the filter body (sidewall porosity) and the head structure (strength, flow-favorable structure).

The filter element may further be manufactured by an additive manufacturing process.

The filter element holder may include at least one mating abutment surface that cooperates with the seal on the sidewall of the head structure of the filter element to seal the filter element with respect to the filter element holder, said seal extending transversely to the longitudinal direction.

The filter element holder may have a sidewall extending basically in the longitudinal direction, and the mating abutment surface may be formed at least partially circumferentially, in particular completely circumferentially, on said basically longitudinally extending sidewall.

In particular, both the filter element and the filter element holder may each have a sidewall that are associated with one another, so that a seal is formed between the two sidewalls in the installed state of the filter element. All of the preceding explanations with respect to possible configurations of the sidewall of the head structure apply analogously also to the sidewall of the filter element holder, it being understood that the two sidewalls have a complementary configuration to each other or each of the sidewalls has a configuration corresponding to the sealing element.

The support plate of the filter element holder may be formed as a stamped and/or deep-drawn sheet-metal part. Such a sheet-metal part can be manufactured quickly and can be easily replaced.

The filter element holder may be provided with a plurality of filter element receptacles, into each of which a separate filter element can be inserted, in particular in such a way that the filter element is held with its head structure in the filter element receptacle.

The filter element receptacle may have a sealing structure that cooperates with the abutment surface formed in the head structure of the filter element.

The filter element receptacle may be formed as an opening in the support plate, the opening being surrounded by a collar projecting from the support plate and at least partially surrounding the opening. The collar may include a collar abutment surface configured to cooperate with the seal formed on the head structure of the filter element to seal a clean fluid space from a raw fluid space.

The collar may extend away from the support plate approximately in the longitudinal direction, in particular parallel to the longitudinal direction.

The collar abutment surface may include a seal retaining structure which may be formed in particular as a recess or groove. The seal retaining structure may be formed over the entire circumference of the collar abutment surface.

The filter element receptacle may be designed such that the filter element can be inserted into the opening of the support plate from the clean fluid space (clean fluid side mounting), or that the filter element can be attached to the opening of the support plate from the raw fluid space (raw fluid side mounting).

The filter device may comprise furthermore a sealing element arranged between the filter element and the filter element holder, in particular between the side surface of the filter element formed on the head structure and the corresponding mating abutment surface of the filter element holder.

Preferably, the filter element holder may form in the filter device a partition between the raw fluid space and the clean fluid space so that, together with one or more filter elements according to the invention, the raw fluid space is sealed from the clean fluid space.

The filter body and the head structure can be manufactured by a sintering process, in particular by infrared sintering. Preferably, plastic particles can be used for this purpose, which then form the filter element when sintered together.

The head structure and the filter body can be manufactured in one piece. This results in rapid production of the filter elements, which can also be fully automated.

All of the advantages and embodiments explained above with reference to the filter element and the filter element holder also apply to the filter device and to the manufacture of a filter element according to the invention and will not be explained again in order to avoid repetitions.

### BRIEF DESCRIPTION OF THE DRAWINGS

The invention will be described in more detail in the following with reference to the exemplary embodiments illustrated in the accompanying figures.

FIG. 1 shows a filter element according to the invention.

FIG. 2 shows a filter element according to the invention for installation on the clean fluid side together with a filter element holder according to the invention in a state in which the filter element is inserted into the filter element holder.

FIG. 3 shows a filter element according to the invention installed in a filter element holder according to the invention.

FIG. 4 shows an enlarged partial sectional view of FIG. 3 through a head structure.

FIG. 5 shows a variant of the filter element according to the invention with a sealing element which has a thickening in the rounded region on a narrow side of the filter element.

FIG. 6 shows a detailed illustration of a variant of a filter element according to the invention for installation on the raw fluid side.

FIG. 7 shows a filter device with a filter element according to the invention and a filter element holder according to the invention.

FIG. 8 shows a process sequence for manufacturing the filter element shown in FIG. 1.

In all figures, the same reference numerals designate components that are identical or similar with respect to their function. Each of these components will be explained in detail only with reference to the embodiment in which the corresponding reference numeral is used for the first time. It is understood that corresponding explanations also apply to the other embodiments in which the respective reference numeral is used. To avoid repetitions, express reference is made to the corresponding description with the first use of the respective reference numeral, unless expressly stated otherwise.

### DETAILED DESCRIPTION

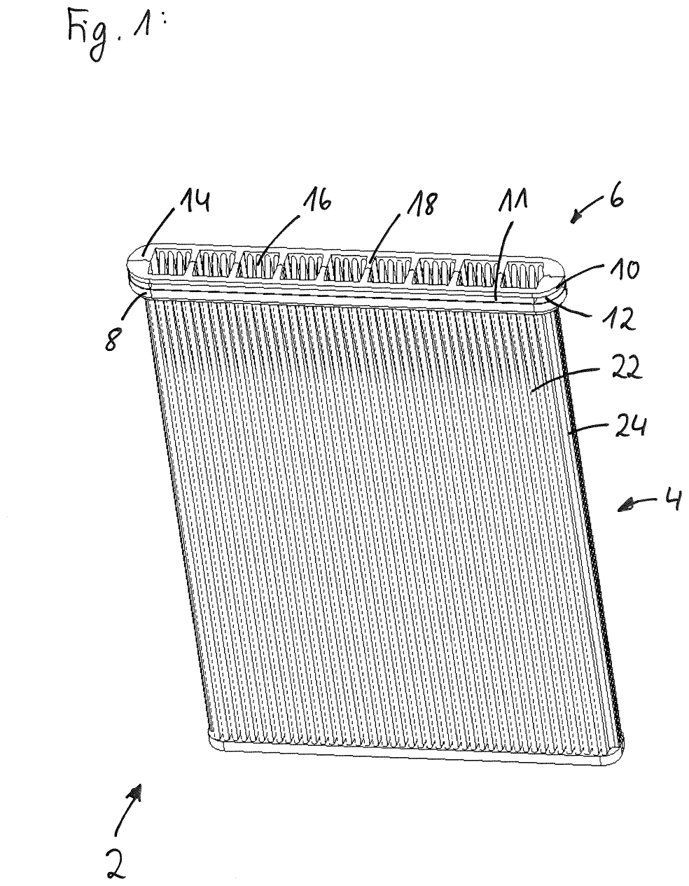

FIG. 1 shows a filter element 2 having a throughflow-porous filter body 4 extending between a head end and a longitudinally opposite foot end.

The filter element 2 has two wide sidewalls 22 and two narrow sidewalls 24 connecting the wide sidewalls. In FIG. 1, only one sidewall 22 and one sidewall 24 are shown. All of the sidewalls 22, 24 extend substantially in longitudinal direction. The wide sidewalls 22 extend in the longitudinal direction and width direction of the filter element 2. The narrow sidewalls 24 extend orthogonally to the wide sidewalls 22 in the longitudinal direction and depth direction of the filter element 2. The sidewalls 22 and 24, together with a foot end wall, not shown, arranged at the foot end of the filter element 2, form a filter pocket or bag and surround a filter body cavity.

The outwardly directed side surfaces of the sidewalls 22 and 24 face a raw fluid space in the installed state. The raw fluid space contains a raw fluid which is contaminated with foreign substances and foreign particles. When the raw fluid passes through the filter element 2, the foreign substances and foreign particles are filtered out, so that a clean fluid cleaned of foreign substances and foreign particles enters into the filter body cavity. During operation of the filter element 2, clean fluid cleaned of foreign substances and foreign particles flows out from this filter body cavity through a clean fluid outlet opening 16 after passing through the filter element. The filter body cavity thus forms part of the clean fluid space located on the clean fluid side of the filter element.

The wide sidewalls 22 have a zig-zag-like or corrugated shape, so that the filter pocket has a lamellar configuration. In this regard, peaks and valleys of the sidewall 22 have a course extending basically in the longitudinal direction of the filter body 4. The peaks and valleys flatten out in the head structure 6 toward the head end of the filter element 2, so that the clean fluid outlet opening 16 in its entirety has a substantially rectangular cross-section. This cross-section enhances the outflow of the clean fluid from the filter cavity of the filter element 2. As an alternative to the lamellar configuration shown, the sidewalls 22 may also be formed as a flat plate. In a form not shown, the filter pocket may also be formed by only three sidewalls or by more than four sidewalls. It is also possible that the sidewalls 22, 24 are arranged at an angle to each other and a cross-section of the filter cavity surrounded by the sidewalls 22, 24 increases toward the clean fluid outlet opening 16. The filter pocket then assumes a slightly funnel-shaped or pyramid-shaped configuration. In addition, it is also possible to form the filter pocket with a rounded or even oval or round cross-section, wherein the filter pocket assumes a tubular frustoconical or conical shape. The sidewalls 22, 24 may even contact each other at the foot end of the filter element, thus eliminating the need for the foot end wall.

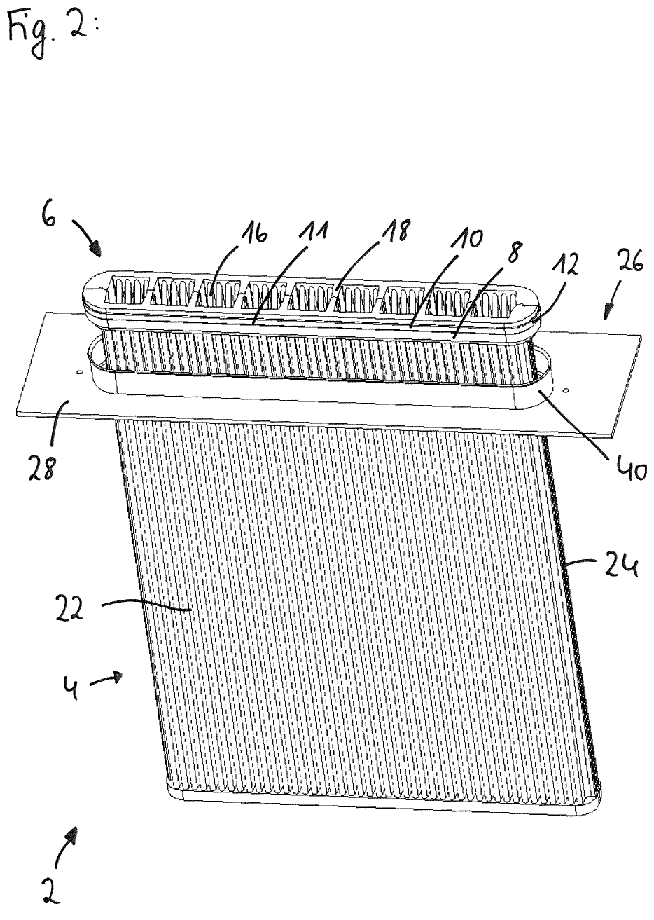

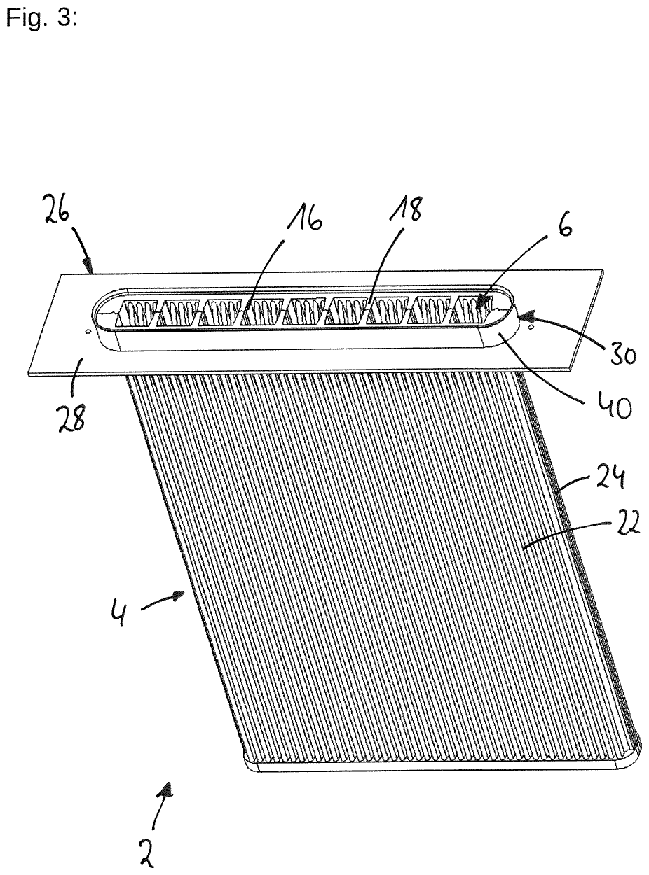

A head structure 6 is formed at the head end of the filter element 2. The head structure 6 comprises a longitudinally extending sidewall 8 formed circumferentially around the clean fluid outlet opening 16. The sidewall 8 comprises two longer/wide portions located opposite each other and extending in the width direction of the filter element 2, as well as two shorter/narrow portions located opposite each other and extending in the depth direction of the filter element 2 and connecting the two longer/wide portions to each other at respective ends of the filter element 2. These shorter/narrow portions are rounded at their outer side. A seal 10 is arranged on the longitudinally extending outer side of the sidewall 8, which is configured to seal the filter element 2 with respect to a filter element holder not shown in FIG. 1 (see FIGS. 2 and 3). The seal 10 can have a recess 11 formed in the sidewall 8 and a sealing element 12 arranged in this recess 11. The sealing element 12 can be designed as a separate seal in the form of an O-ring, a delta ring, an X-ring, a T-ring, a foamed-on seal or a fiber seal. In the embodiment shown, the recess 11 has the configuration of a groove formed in the sidewall 8, extending orthogonally to the longitudinal direction around the entire sidewall 8 and thus completely surrounding the clean fluid outlet opening 16. The seal 10 thus extends along a circumference of the head structure 6 surrounding the clean fluid outlet opening 16 along the sidewall 8. It is also possible to form another sealing structure on the outside of the sidewall 8 with which the sealing element 12 cooperates (e.g. a bead), or even for the sealing element 12 to cooperate with an outside of the sidewall 8 that is not further structured.

In the embodiment shown in FIG. 1, the seal 10 is formed by a sealing element 12 which cooperates with the filter element holder. There are also embodiments conceivable in which no sealing element 12 is necessary. For example, the seal 10 may have an abutment surface which may be formed, for example, on a groove formed in the sidewall 8 or on a bead or material extension projecting from the sidewall 8. In such embodiments, the filter element holder into which the filter element 2 is inserted will be provided with a corresponding complementary structured mating abutment surface, so that when the filter element is inserted, a kind of labyrinth seal is obtained. In further alternative embodiments, the sidewall 8 may have a material structure in a region which, when abutting on the filter element holder, provides a sealing effect between the sidewall 8 and the filter element holder. This may be effected by machining the sidewall 8 differently in the region provided for sealing than in the remainder of the sidewall 8, such as having a rougher surface than the remainder of the sidewall 8.

The seal 10 is formed in a region of the sidewall 8 that is near the head end of the filter element 2. A different position of the seal 10 on the sidewall 8 is also possible. The head structure 6 may further comprise a plurality of seals 10 arranged longitudinally one after the other to form a plurality of fluid barriers. This may provide greater security in separating a clean fluid space from raw fluid space.

The head structure 6 comprises furthermore a head-side end wall 14, which is arranged at the head end of the filter element 2 and in which the clean fluid outlet opening 16 is formed. The sidewall 8 of the head structure 6 surrounds the clean fluid outlet opening 16 as a circumferential outer boundary. In addition to the two shorter sections of the sidewall 8, the two opposite longer sections of the sidewall 8 are connected to each other by a total of seven webs 18, so that the clean fluid outlet opening 16 is divided into eight partial clean fluid outlet openings. It is understood that a smaller or larger number of partial clean fluid outlet openings is also possible. It is even possible that there are no webs 18 at all, so that the head structure 6 has a continuous clean fluid outlet opening 16 surrounded by the sidewall 8. The two narrower sections of the sidewall 8 extend in the depth direction and confine the head structure 6 in the width direction. In the embodiment shown in FIG. 1, the narrower sections of the sidewall 8 are rounded on the outer side so that the outer side is convex. Thus, the sidewall 8 has an outwardly curving outer surface in the region of the narrower sections. Alternatively, the narrower sections of the sidewall 8 could also be formed in a straight line or even concave on their outer side. The convexly rounded design of the narrower sections of the sidewall 8 permits a reduction of stresses in the head structure 6, in particular as a result of temperature fluctuations, and thus increases the durability of the filter element 2. This has a particular effect when the filter element is exposed to higher operating temperatures. In addition, the convexly rounded shape of the narrow sections of the sidewall 8 facilitates the installation and removal of the filter element 2.

The head structure 6 is configured to insert the filter element 2 into a filter element holder 26 shown in FIGS. 2 to 4, where it is held for operation in a filter device. FIG. 2 shows the filter element 2 in a configuration for installation on the clean fluid side, in which the filter element 2 is inserted into the filter element holder 26 from the clean fluid space. FIG. 2 shows the filter element 2 in a position during installation, in which the filter element 2 has not yet reached a final position, but is in an intermediate position on the way to its final position. FIG. 3 shows the filter element 2 in its final position in the filter element holder 26.

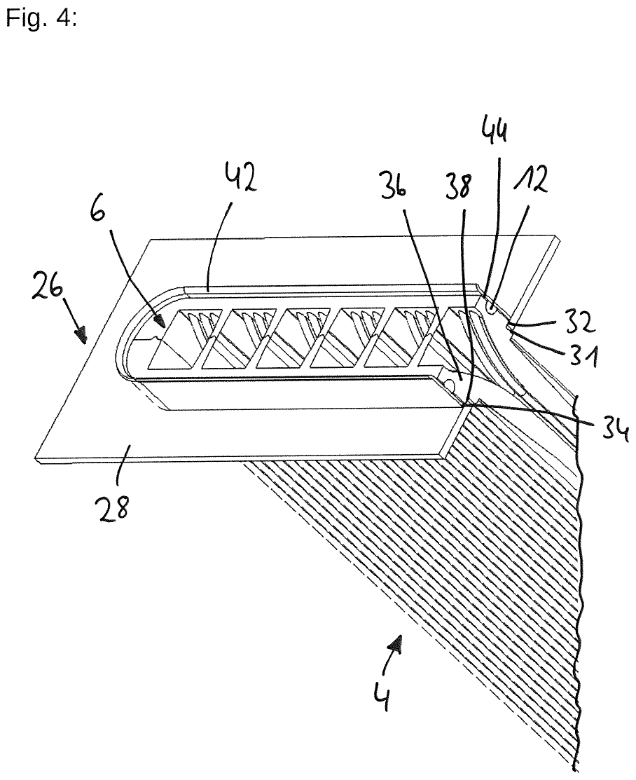

The filter element holder 26 has a support plate 28 in which at least one filter element receptacle 30 is formed. The support plate 28 may, for example, be formed as a stamped or deep-drawn sheet-metal part, with the filter element receptacle 30 having an opening 31 stamped out from the sheet-metal part, and a collar attached to the edge of the opening 31. As can be seen in the sectional view of FIG. 4, the sidewall 8 of the head structure 6 may form at least one outwardly projecting protrusion 36 on which is formed an end face 38 facing towards the foot end of the filter element 2. Alternatively, such a protrusion may project outwardly on the head structure 6 in the region of the sidewall 8. When the filter element 2 is inserted into the filter element holder 26, the end face 38 formed on the head structure 6 in the end position comes to abut on a mating abutment surface 34 of the filter element holder 26, which prevents further displacement of the filter element 2 relative to the filter element holder 26 in the insertion direction.

In its installation position shown in FIG. 3, the filter element 2 is inserted with its head structure 6 into the filter element receptacle 30 and retained there. For installation, the filter body 4 of the filter element 2 is passed with its foot end first in the insertion direction from the clean fluid side through the opening 31 of the filter element receptacle 30 until the protrusion 36 formed on the head structure 6, which forms a retaining structure, abuts with the end surface 38 directed toward the foot end of the filter element 2 on a mating abutment surface 34 of the protrusion 32 formed on the filter element receptacle 30, thus blocking further movement of the filter element 2 in the insertion direction.

In the installed state, the filter body 4 projects into the raw fluid space of a filter device that is not shown, and the head structure 6 is partially disposed in the clean fluid space. As will be explained in more detail below, the head structure 6 thus seals the clean fluid space with respect to the raw fluid space by way of abutment of the sealing element 12 on the collar 40 and also ensures that the filter element 2 is supported on the support plate 28 by abutment of the end face 38 on the mating abutment surface 34.

The collar 40 of the filter element receptacle 30 surrounding the opening 31 extends in the longitudinal direction approximately orthogonally away from the support plate 28. An end 42 of the collar 40 facing away from the support plate 28 is bent radially outwardly to form an insertion aid to facilitate insertion of the head structure 6 into a receiving space 41 formed by the collar 40 when the filter element 2 is inserted. The collar is preferably arranged slightly recessed from the edge of the opening 31 and is formed to exactly fit the protrusion 36 on the head structure 6. In this way, the portion of the support plate 28 projecting towards the edge of the opening 31 forms a protrusion 32 having a mating abutment surface 34 against which the end face 38 formed on the protrusion 36 of the head structure 6 of the filter element 2 comes into abutment.

The collar 40 has an inner surface 42 with a collar abutment surface 44 that is located opposite the seal 10 of the head structure 6 when the filter element 2 is installed. The collar abutment surface 44 is configured to seal the raw fluid space from the clean fluid space together with the seal 10, in the example illustrated with the sealing element 12. The collar abutment surface 44 may include a recess or groove configured to provide a snug fit of the seal 10 in the installed state. In the case where a sealing element 12 is used, the recess or groove may be configured in particular for receiving the sealing element 12. The collar abutment surface 44 is preferably arranged completely circumferentially around the inner surface 42 of the collar 40.

With the design of the filter element and filter element holder according to the invention, in addition to sealing structures whose function is to separate the raw fluid space from the clean fluid space, in particular the sidewall 8, the collar abutment surface 42 and, if applicable, the sealing element 12, there are provided still further structures which hold the filter element 2 in the filter element holder 26, in particular the protrusions 32 and 36. It has been shown that this design, in which the sealing structures do not have to take up forces required to hold or securely support the filter element 2 in the filter element holder 26, permits considerably easier and better automatable manufacture of filter elements 2 and filter element holders 26.

In the exemplary embodiment, the filter element 2 is formed integrally. This means that the filter body 4 and the head structure 6 are made of the same material. The material may be a sintered particulate material, in particular plastic particles sintered together. Nevertheless, the filter body 4 and the head structure 6 may have different configurations, or there may be structural differences between the filter body 4 and the head structure 6. In particular, for the filter body 4, it is desired to have a sufficiently porous structure and to allow passage of fluid to be filtered with acceptable pressure loss. On the other hand, for the head structure 6, sufficient rigidity is primarily sought to securely receive and support the filter element 2 in the filter element holder 26. In this regard, the filter element 2 may be manufactured, in particular, by infrared sintering. This allows easy control of the porosity of the filter element in regions forming the filter body 4 and the head structure 6, with regions for the filter body 4 having a different porosity than regions in which the head structure 6 is formed. In particular, the filter body 4 has a higher porosity than the head structure 6. In contrast, the head structure is more rigidly formed, i.e. more strongly sintered together, than the filter body.

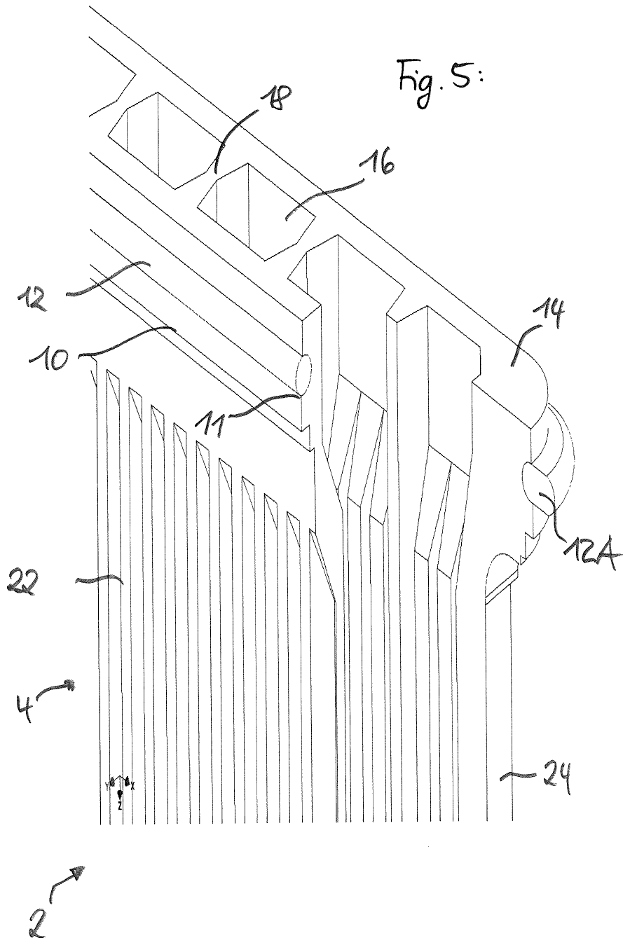

FIG. 5 shows a variant of the filter element 2 according to the invention with a sealing element 12, which has a thickening 12A in the two rounded areas on the narrow sides of the filter element 2. It should be noted once again that the same reference numerals are used in FIG. 5 as in FIGS. 1 to 4, insofar as in each case the same components or similar components with respect to their function are designated. In the following, only the differences in the embodiment according to FIG. 5 will be explained in more detail, and for an explanation of the other components reference is made to the description of FIGS. 1 to 4 which applies also to the embodiment according to FIG. 5.

Also in the embodiment according to FIG. 5, the head structure 6 comprises a longitudinally extending sidewall 8 which is formed circumferentially around the clean fluid outlet opening 16. The sidewall 8 comprises two longer portions located opposite each other and extending in the width direction of the filter element 2, and two shorter portions located opposite each other and extending in the depth direction of the filter element 2 and connecting the two longer portions to each other at a respective end of the filter element 2. These shorter portions are rounded at their outer side. A groove 11 is formed on the outer side of the sidewall 8, extending around the clean fluid outlet opening 16, in which a sealing element 12 formed as a sealing ring is accommodated. In the exemplary embodiment shown, the sealing element 12 has a substantially round cross-section.

It has been found that in the case of filter elements 2 which are subject to higher temperatures of 50° C. or more in operation, the filter elements 2 can exhibit noticeable thermal expansion. This thermal expansion is particularly pronounced in the width direction of the filter element 2, as compared to the direction parallel to the longer side surfaces 22 of the filter element 2. For this reason, in the embodiment according to FIG. 5, the sealing element 12 is formed with a larger cross-section in the shorter rounded portions of the sidewall 8 which extend in the depth direction and connect the two longer portions, than in the other portions of the sealing element 12. The sealing element 12 thus has a thickening in these portions, which is illustrated in FIG. 5 by way of reference numeral 12A. It can be seen in FIG. 5 that the sealing element 12 adopts a more elliptical cross-section in the regions of the thickening 12A, with the greatest extension of the thickening 12A pointing in the width direction of the filter element 2. However, it should be emphasized that the illustrated design of the sealing element 12 with a thickening 12A is also possible and useful when using sealing elements with a different cross-sectional shape (e.g. rectangular or trapezoidal) in order to compensate for strong thermal expansion of the filter element 2 in a certain direction.

Due to the larger cross-section of the sealing element 12 in the region of the thickened portions or thickenings 12A, the sealing element can be compressed to a greater extent in the direction of its largest cross-section in the region of the thickenings 12A than in the other regions of the sealing element 12. In a sense, a compression path is extended by which the sealing element 12 can be compressed. The thickenings 12A are formed such that the direction of the largest cross-section in the region of the thickenings 12A points in the width direction of the filter element 2, that is, in the direction in which the largest thermal expansion of the filter element 2 occurs during operation. In this manner, the thickened portions 12A of the sealing element 12 provide an additional amount of elastic or compressible material that can be compressed as the thermal expansion of the filter element 2 occurs mainly in the width direction. In this way, the sealing element 12 compensates for the additional thermal expansion of the filter element 2 in the width direction.

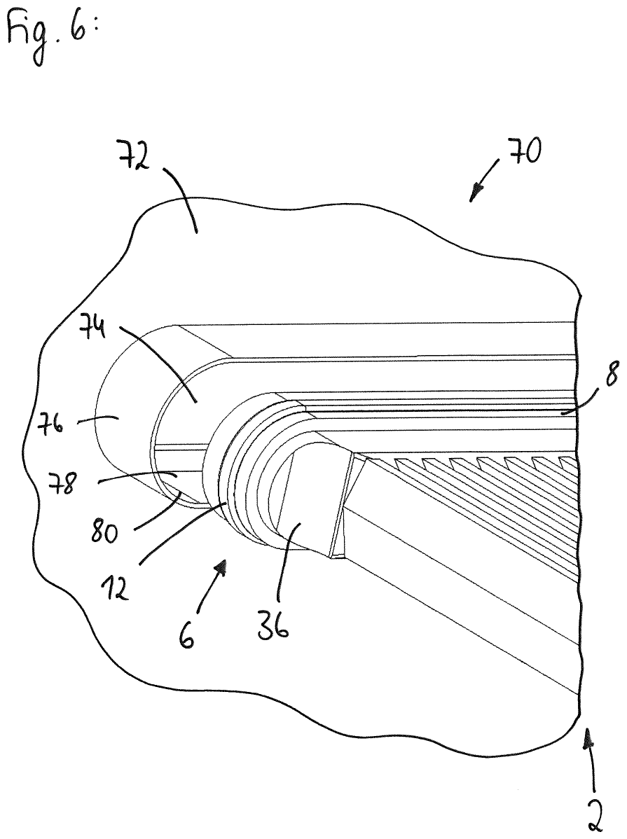

FIG. 6 shows a detailed view of a variant of the filter element 2 according to the invention for installation in a filter element holder 70 from the raw fluid side. The same reference numerals are also used in FIG. 6 as in FIGS. 1 to 5, insofar as in each case the same components or similar components with respect to their function are designated. In the following, only the differences in the embodiment according to FIG. 6 will be explained in more detail and, for elucidating the additional components, reference is made to the description of FIGS. 1 to 5, which applies analogously to the embodiment according to FIG. 6.

The filter element holder 70 includes a support plate 72 having an opening 74. Surrounding the opening 74 is a collar 76 which extends in the longitudinal direction away from the support plate 72 and which, together with the support plate 72, surrounds a filter element receptacle 78. In the installed state, the collar 76 projects into the raw fluid space of a filter device. The filter element support 70 and the collar 76 are formed similarly to the filter element support 26 and the collar 40. When the filter element 2 is installed, the filter element 2 is inserted with its head structure 6 from the raw fluid side into the space formed between the collar 76 and the support plate 72, which forms the filter element receptacle 78, so that the sidewall 8 of the head structure 6 of the filter element 2 is located opposite a collar abutment surface 80 formed on the inside of the collar 76, and the head structure 6 is located mainly in the raw fluid space. Between the sidewall 8 and the collar abutment surface 80 the sealing element 12 is located in sealing abutment with the sidewall 8 and the collar abutment surface 80. In the installed state, the filter element 2 is secured to the support plate 72 by a fastener not shown, for example by a clamp or sheet-metal part which is attached to the collar 76 or the support plate 72 from the raw fluid side and engages over the protrusion 36 formed on the head structure 6 of the filter element 2 so that the head structure 6 is clamped between the support plate 72 and the clamp or sheet-metal part. Alternatively, the head structure may be secured also by screws or the like passing through the support plate 72 from the clean fluid side and threaded into a thread in the head structure 6. Another possibility is that one or more screws or bolts are screwed into the head structure 6 through the collar 76.

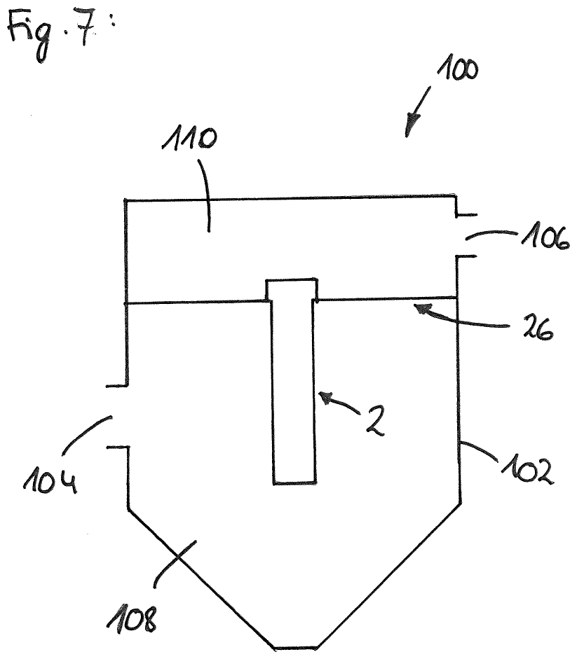

FIG. 7 schematically illustrates a filter device 100 comprising a housing 102 having a raw fluid inlet 104 and a clean fluid outlet 106. In the housing 102, the filter element holder 26 with the inserted filter element 2 is arranged such that the filter element holder 26 and the filter element 2 separate a raw fluid space 108, into which the raw fluid inlet 104 opens, from a clean fluid space 110, which is connected to the clean fluid outlet 106. In the filter device 100, the filter element holder 26 is arranged horizontally and the filter element 2 projects orthogonally thereto into the raw fluid space 108. In FIG. 7, a clean fluid side installation type of the filter element 2 in the filter element holder 26 is shown. This means that the filter element 2 is installed from the clean fluid space 110 into the filter element holder 26 and projects through the filter element holder 26 into the raw fluid space 108. Filter elements 2 suitable for installation on the clean fluid side are shown in FIGS. 1 to 5. As an alternative to the installation on the clean fluid side as shown in FIG. 7, the filter element 2 can also be installed in the filter element holder 26 on the raw fluid side. For this purpose, the filter element 2 is placed with its head structure from the raw fluid space 108 onto the filter element holder 26. A filter element 2 suitable for installation on the clean fluid side is shown in FIG. 6.

As an alternative to the horizontal orientation of the filter element holder 26, it is also possible to arrange the filter element holder vertically or at a different angle relative to the housing 102. This means that the filter element 2 in the alternative embodiment can also have a different orientation relative to the housing 102.

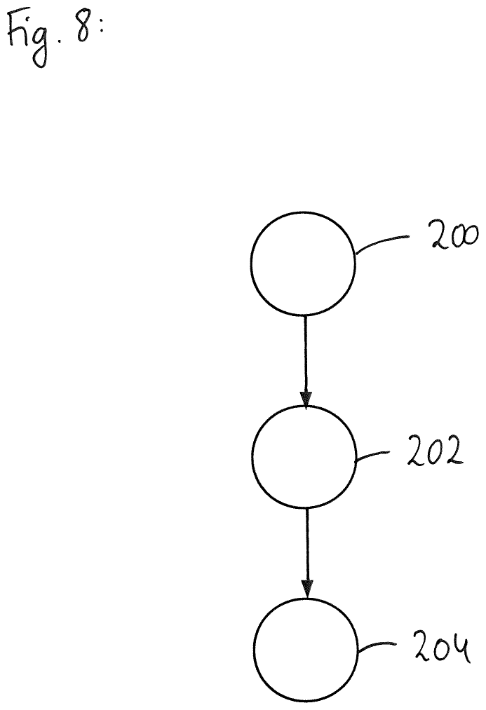

FIG. 8 shows a process flow for manufacturing the filter element 2, wherein the manufacture of the filter element 2 is automated. The method comprises manufacturing the throughflow-porous and inherently stable filter body 4 and forming the head structure 6 on the filter body 4. In doing so, the head structure 6 is provided with the at least one seal 10 configured to cooperate with the filter element holder 26 of the filter device 80 to seal the clean fluid space 110 with respect to the raw fluid space 88.

In a first step 200, preferably a particulate plastic material is filled into a sintering mold. In a step 202, the sintering mold is heated so that the particulate plastic material forms a throughflow-porous and inherently stable filter body 4. The sintering mold is heated differently or more strongly in a region in which the head structure 6 of the filter element 2 is formed on the filter body 2 or together with the filter body 2, so that a more rigid and almost fluid-impermeable material structure is formed in the region of the head structure 6. A transition between the filter body 4 and the head structure 6 has a lower porosity than the filter body 4 and a higher porosity than the head structure 6. The sintering mold may comprise a structure used to form the seal 10, or in any case to form a structure belonging to the seal 10, such as a recess or groove 11 for receiving a sealing element 12. Alternatively, the seal 10 may also be formed in a step following the sintering process, which may be automated as well. For achieving zones with different heat supply to regions of the sintering mold in which the plastic material filled into the sintering mold is to form the filter body 4, and regions in which the plastic material filled into the sintering mold is to form the head structure 6, the sintering can be carried out in particular by infrared sintering. In this way, it is particularly easy to control the respective desired porosity or stiffness of the filter element 2 in different regions. The method can be carried out in such a way that the filter body 4 is formed integrally or in one piece with the head structure 6. For this reason, no additional fasteners need to be used to connect the filter body 4 and the head structure 6. After the filter element 20 has cooled in the sintering mold, it can be removed from the sintering mold in a step 204. This is preferably done by opening the sintering mold and lifting the filter element out of the sintering mold.

1. A filter element comprising a throughflow-porous filter body extending between a head end and a longitudinally opposite foot end;
wherein a head structure is formed at the head end of the filter element, said head structure having at least one seal configured to seal the filter element with respect to a filter element holder,
wherein the head structure has a sidewall extending basically in the longitudinal direction and the seal is formed on said basically longitudinally extending sidewall of the head structure of the filter element.

2. The filter element according to claim 1,
wherein the seal is formed on the sidewall of the head structure so as to extend one of at least partially circumferentially, around a clean fluid outlet opening formed in the head structure.

3. The filter element according to claim 1,
wherein the seal has a sealing element extending transversely to the longitudinal direction in order to seal the filter element with respect to the filter element holder, wherein the sealing element is selected from the group consisting of an O-ring, a delta ring, an X-ring, a T-ring, a foamed-on seal and a fiber seal.

4. The filter element according to claim 3,
wherein the sidewall has a recess for receiving the sealing element, wherein the recess extends orthogonally to the longitudinal direction.

5. (canceled)

6. (canceled)

7. The filter element according to claim 4,
wherein the sidewall comprises a plurality of recesses.

8. (canceled)

9. The filter element according to claim 1,
wherein the filter element comprises at least one of three sidewalls, as well as at least one foot end wall connecting the sidewalls to one another at the foot end, wherein the filter element comprises two wide sidewalls and two narrow sidewalls connecting the two wide sidewalls to one another, wherein a region of the sidewalls forms the filter body, wherein at least one of the two wide sidewalls is formed in a zig-zag-like or corrugated manner, wherein peaks and valleys of the at least one sidewall have a course extending in the longitudinal direction of the filter element, wherein the peaks and valleys in the head structure flatten toward the head end so that a clean fluid outlet formed in the head structure has a substantially rectangular cross-section for the clean fluid flow.

10. (canceled)

11. (canceled)

12. (canceled)

13. (canceled)

14. (canceled)

15. The filter element according to claim 1,
wherein the head structure forms at least one outwardly projecting protrusion adapted to cooperate with a retaining structure formed on the filter element holder so as to secure the filter element against displacement in the longitudinal direction against displacement in the insertion direction.

16. The filter element according to claim 1,
wherein the head structure projects outwardly in the region of the sidewall at least in a portion thereof, so that the head structure forms a protrusion forming an end face that is directed towards the foot end of the filter body and cooperates with a mating end face formed on the filter element holder in order to secure the filter element against displacement in the longitudinal direction.

17. The filter element according to claim 1,
wherein the head structure is formed integrally with the filter body.

18. The filter element according to claim 1,
wherein the filter body is formed of a sintered particulate material and the head structure is integrally sintered together with the filter body, wherein the filter body and the head structure are composed of plastic particles sintered together.

19. (canceled)

20. The filter element according to claim 1,
wherein the filter body and the head structure are manufactured by infrared sintering or by an additive manufacturing process.

21. (canceled)

22. A filter element holder adapted to receive a filter element according to claim 1, comprising:
a support plate having at least one filter element receptacle into which the filter element can be inserted in such a way that the filter element is seated with its head structure in the filter element receptacle, wherein the filter element receptacle comprises a sealing structure cooperating with the seal formed in the ad structure of the filter element.

23. The filter element holder according to claim 22,
wherein the support plate comprises at least one of a stamped and/or deep-drawn sheet-metal part, and/or wherein the filter element receptacle comprises a collar extending away from the support plate in the longitudinal direction, wherein the collar comprises a collar abutment surface adapted to cooperate with the seal of the filter element for sealing a raw fluid space from a clean fluid space.

24. (canceled)

25. (canceled)

26. (canceled)

27. The filter element holder according to claim 23,
wherein a seal retaining structure, includes a recess that is formed on the collar abutment surface which is adapted to receive the seal provided on the sidewall of the head structure;
wherein the seal retaining structure is formed so as to extend over an entire circumference of the collar abutment surface.

28. A combination of a filter element according to claim 1 and a filter element holder according to claim 23, into which the filter element can be inserted, such that the filter element in the inserted state separates a raw fluid space from a clean fluid space of a filter device,
wherein the sidewall of the head structure and the filter element receptacle cooperate to seal the filter element with respect to the filter element holder, in cooperation with a sealing element extending transversely to the longitudinal direction.

29. A filter device comprising a raw fluid space;
a clean fluid space;
wherein the filter device comprises at least one combination of at least one filter element and one filter element holder according to claim 28,
wherein the filter element is inserted into a filter element receptacle formed in the filter element holder, such that the filter element in the inserted state separates the raw fluid space from the clean fluid space.

30. A method of manufacturing a filter element, comprising:
producing a throughflow-porous and inherently stable filter body, and
forming a head structure on the filter body, wherein the head structure is provided with at least one seal adapted to cooperate with a filter element holder of a filter device so as to seal a clean fluid space from a raw fluid space of the filter device, wherein the manufacture of the filter element is automated.

31. The method according to claim 30, wherein the seal comprises a sealing element extending transversely to the longitudinal direction for sealing the filter element with respect to the filter element holder, and/or wherein the head structure is provided with a basically longitudinally extending sidewall and the seal is formed on said basically longitudinally extending sidewall, and/or wherein the head structure is formed to cooperate with the filter element holder of the filter device so as to fix the filter element in the filter element holder.

32. (canceled)

33. (canceled)

34. The method according to claim 30,
wherein the filter body and the head structure are produced by a sintering process, in particular from plastic particles sintered together, wherein the filter body and the head structure (6) are produced by infrared sintering.

35. (canceled)

36. The method according to claim 30,
wherein the head structure and the filter body are manufactured in one-piece form.
